(19) United States
(12) Patent Application Publication
(10) Pub. No.: US 2023/0308306 A1
(43) Pub. Date: Sep. 28, 2023

(54) HOUSEHOLD APPLIANCES WITH PERSONALITY MANAGEMENT

(71) Applicant: Haier US Appliance Solutions, Inc., Wilmington, DE (US)

(72) Inventors: Haitian Hu, Louisville, KY (US); Hairong Li, Louisville, KY (US); John Ouseph, Louisville, KY (US)

(21) Appl. No.: 17/705,736

(22) Filed: Mar. 28, 2022

(51) Int. Cl. H04L 12/28; G06F 12/0804

(52) U.S. Cl. CPC H04L 12/2814; H04L 12/2825; G06F 12/0804; H04L 2012/285; G06F 2212/7204

(57) ABSTRACT

Methods of operating a household appliance may include storing a personality of the household appliance in one or both of a remote computing device and a local memory of the household appliance. The personality of the household appliance may be stored in a partition of the local memory separate from control software of the household appliance. The personality of the household appliance may be synchronized between the remote computing device and the local memory, such as two-way synchronization.

### FIELD OF THE INVENTION

The present subject matter relates generally to household appliances, and more particularly to systems and methods for managing a personality of a household appliance.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a dishwasher, etc., along with room air conditioners and other various appliances.

Household appliances offer numerous options for reconfiguring operating parameters thereof, such as by the appliance owner, a technician (e.g., during repair or maintenance of the household appliance), or a system engineer (e.g., by a system-wide update to all household appliances of a certain type, model, or common feature set). Such reconfigurations may be made by input received locally, e.g., on a user interface of the household appliance itself, or remotely, e.g., through a remote computing device and/or distributed computing system such as the cloud.

Thus, there is a need to synchronize unit-specific household appliance configuration information across multiple sources, such as reconfigurations made locally and remotely, in order to ensure the household appliance retains all desired settings. For example, one or more redundant backups of the household appliance configuration information, including prior versions and revision history thereof, would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a household appliance is provided. The method includes storing a personality of the household appliance in a local memory of the household appliance. The method also includes connecting the household appliance to a remote computing device and storing the personality of the household appliance in the remote computing device. The method further includes receiving an input comprising an updated value for a parameter of the personality of the household appliance. The parameter of the personality of the household appliance is modified in response to the input. The method also includes updating the personality of the household appliance in the local memory of the household appliance with the modified parameter and updating the personality of the household appliance in the remote computing device with the modified parameter.

In another exemplary aspect of the present disclosure, a method of operating a household appliance is provided. The household appliance includes a controller that has a partitioned memory. The partitioned memory includes a personality partition and a control partition. The method includes storing a personality of the household appliance in the personality partition. The method also includes copying the personality of the household appliance from the personality partition to the control partition and storing the personality of the household appliance in the control partition. The method further includes updating the control partition. The method also includes restoring the personality of the household appliance in the control partition from the personality partition.

In yet another exemplary aspect of the present disclosure, a method of operating a household appliance is provided. The method includes storing a personality of the household appliance in a remote computing device. The method also includes copying the personality of the household appliance from the remote computing device to a local memory of the household appliance and storing the personality of the household appliance in the local memory. The method further includes updating the local memory. The method also includes restoring the personality of the household appliance in the local memory from the remote computing device.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a side cross-sectional view of the exemplary washing machine appliance of FIG. 1.

FIG. 3 provides a perspective view of the exemplary dryer appliance of FIG. 1 with portions of a cabinet of the laundry appliance removed to reveal certain components of the dryer appliance.

FIG. 4 provides a partial perspective view of an exemplary air conditioner appliance in accordance with additional embodiments of the present disclosure.

FIG. 5 provides a perspective view of a refrigerator appliance in accordance with one or more additional exemplary embodiments of the present disclosure.

FIG. 6 provides a flow chart illustrating an exemplary method of operating a household appliance in accordance with at least one embodiment of the present subject matter.

FIG. 7 provides a flow chart illustrating another exemplary method of operating a household appliance in accordance with one or more additional embodiments of the present subject matter.

FIG. 8 provides a flow chart illustrating another exemplary method of operating a household appliance in accordance with one or more additional embodiments of the present subject matter.

FIG. 9 provides a flow chart illustrating another exemplary method of operating a household appliance in accordance with one or more additional embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

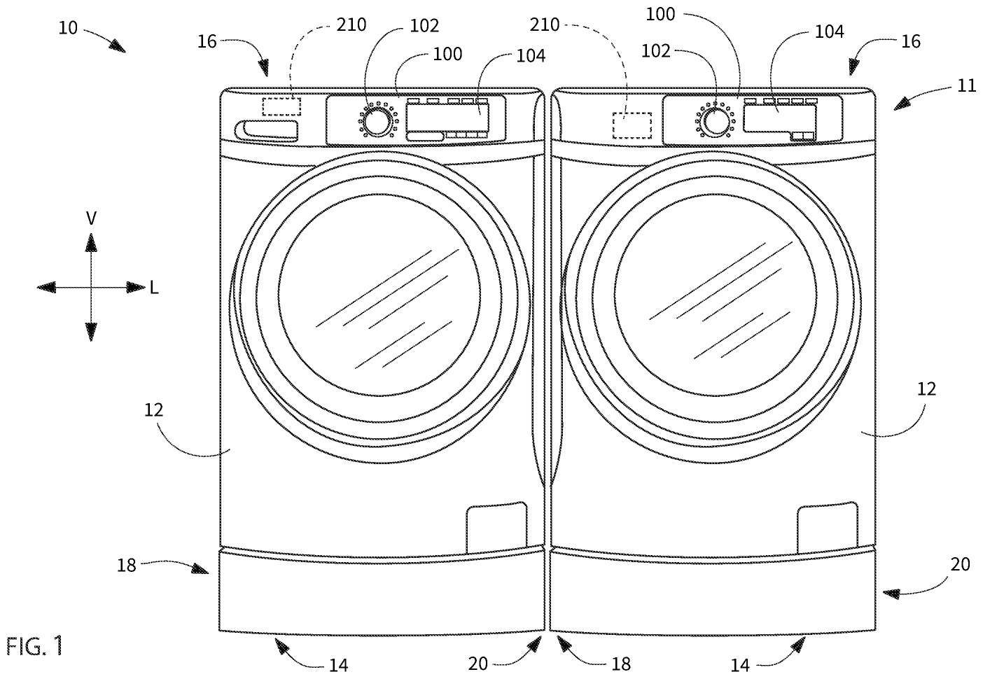

As may be seen in FIGS. 1 through 3, in accordance with one or more embodiments of the present subject matter, a household appliance may be a washing machine appliance 10 or a dryer appliance 11. The dryer appliance 11 is separately labelled in FIG. 1 to distinguish the dryer appliance 11 from the washing machine appliance 10, where both the washing machine appliance 10 and the dryer appliance 11 are example embodiments of a household appliance 10 which may be usable in one or more exemplary methods described herein and/or may be operable and configured to perform such methods.

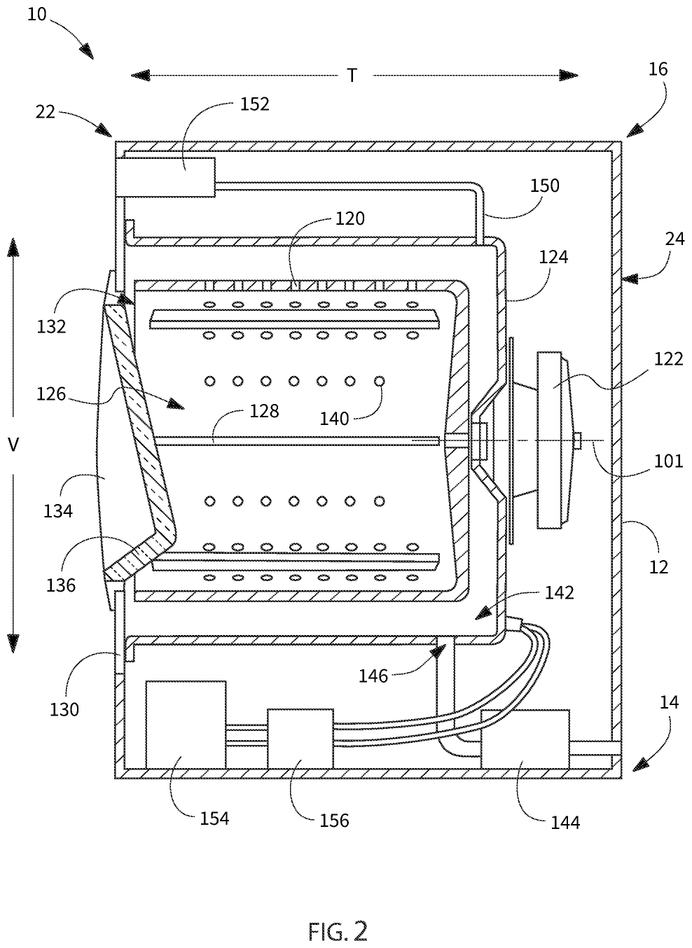

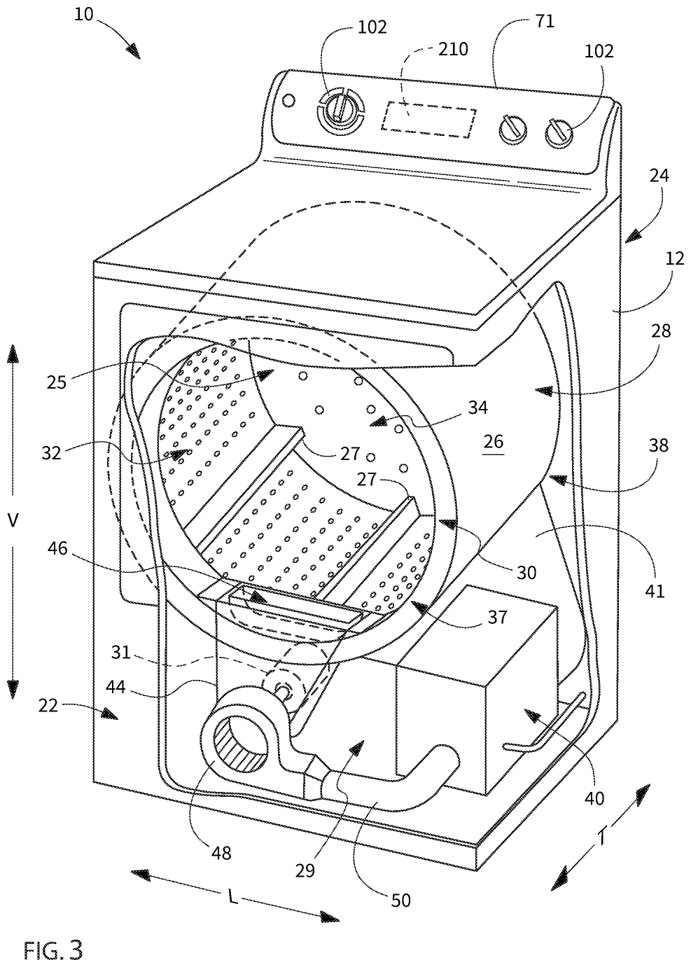

As generally seen throughout FIGS. 1 through 5, in at least some embodiments, the household appliance 10 or each appliance 10 includes a cabinet 12 which defines a vertical direction V, a transverse direction T, and a lateral direction L that are each mutually perpendicular to every other. Each cabinet 12 extends between a top side 16 and a bottom side 14 along the vertical direction V. Each cabinet 12 also extends between a left side 18 and a right side 20, e.g., along the lateral direction L. The cabinet 12 may also extend between a front side 22 and a rear side 24 (FIGS. 2 and 3), e.g., along the transverse direction T.

Each household appliance 10 may include a user interface panel 100 and a user input device 102 which may be positioned on an exterior of the cabinet 12. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be the user input device 102 or one of the input devices 102.

Generally, each appliance 10 may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance 10. Operation of the appliance 10 may be regulated by the controller 210 that is operatively coupled to the corresponding user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance 10 or 11. Each controller 210 may include a memory and one or more microprocessors, CPUs or the like, such as general or special purpose microprocessors operable to execute programming instructions or micro-control code associated with operation of the appliance 10. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the respective appliance 10 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the household appliance 10 and 11 may be one (or both) of a pair of laundry appliances. In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each household appliance 10 and 11.

Additional exemplary details of the laundry appliances are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance of FIG. 1, which is an example embodiment of a household appliance 10, with a portion of a cabinet or housing 12 of dryer appliance 10 removed in order to show certain components of dryer appliance 10. Dryer appliance 10 generally defines a vertical direction V, a lateral direction L, and a transverse direction T, each of which is mutually perpendicular, such that an orthogonal coordinate system is defined. While described in the context of a specific embodiment of dryer appliance 10, using the teachings disclosed herein, it will be understood that dryer appliance 10 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 10 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 10.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 10 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on a cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 10 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller.

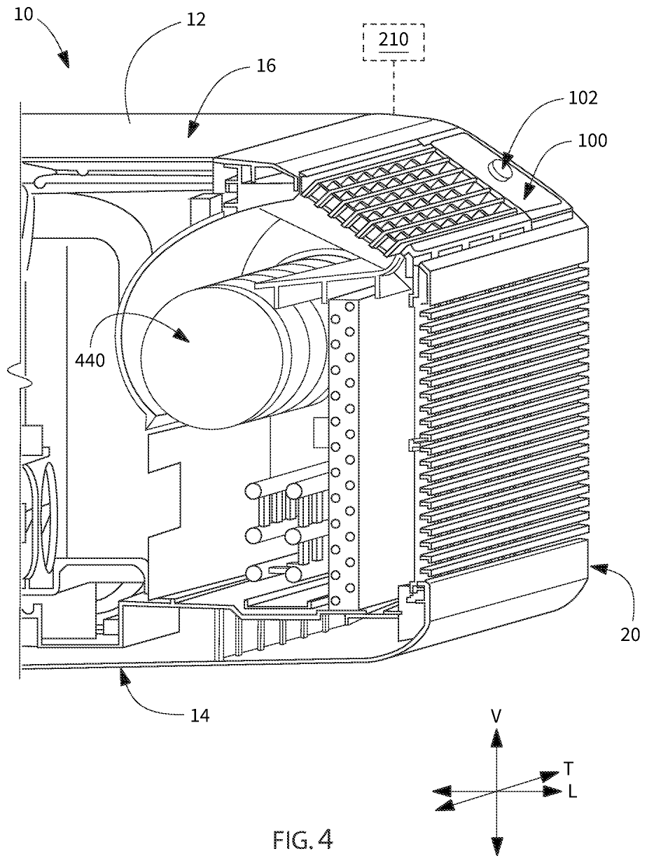

In another example embodiment, the appliance 10 may be an air conditioning appliance, e.g., as illustrated in FIG. 4. FIG. 4 illustrates another example embodiment of a household appliance 10, wherein the appliance 10 is a room air conditioner. As illustrated, the exemplary air conditioner 10 includes cabinet 12, user interface panel 100 and user input device 102. In the illustrated example of FIG. 2, the user input device 102 is a control knob. The air conditioner 10 may also include a controller 210, and the controller 210 may be configured to activate a mechanical component of the air conditioner 10, e.g., by turning on fan 440 to circulate air.

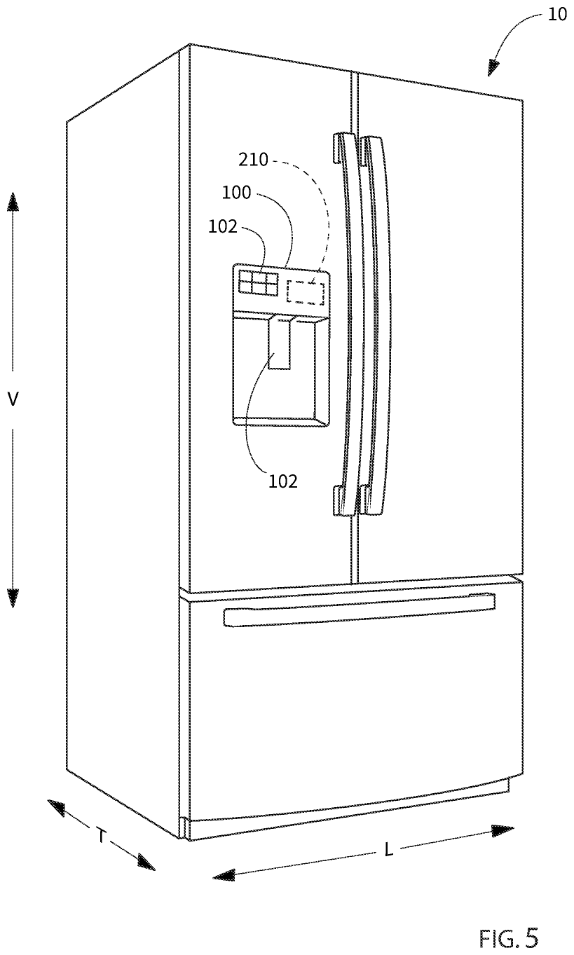

In another example embodiment, the appliance 10 may be a refrigerator appliance, such as is illustrated in FIG. 5. The refrigerator appliance 10 of FIG. 5 is another exemplary embodiment of a household appliance as described herein throughout. Refrigerator appliance 10 is generally referred to as a bottom-mount refrigerator appliance. It should be understood that refrigerator appliance 10 is provided by way of example only. Thus, the present subject matter is not limited to refrigerator appliance 10 and any suitable refrigerator appliance may be utilized in the methods and systems of the present disclosure, e.g., a side-by-side or top mount refrigerator appliance, a refrigerator appliance having different dispenser features (or none at all), and/or a refrigerator appliance having a touchscreen on one of the doors thereof, among other possible variations.

Still referring to FIG. 5, the refrigerator appliance may include a dispenser, e.g., coupled to the user interface panel 100, which may be configured to dispense cold water, hot water, and/or ice. In such embodiments, the user inputs 102 may include, for example, touch inputs (e.g., buttons, touch pad, or touch screen) on the user interface panel 100 and a mechanical actuator or switch for activating the dispenser. As illustrated, dispenser may include a dispenser recess defined on one of the refrigerator doors. The dispenser may include one or more outlets for dispensing ice, chilled liquid water, and/or heated liquid water. Dispenser may, for example, include a paddle 102 (which is an embodiment of a user input for activating the dispenser) mounted below the one or more outlets. As illustrated, the user inputs 102 on the user interface panel 100 may be manipulated, e.g., pressed, to control or select the mode of operation of dispenser, e.g., for selecting chilled liquid water, heated liquid water, crushed ice, and/or whole ice. User interface panel 100 may include a chilled water dispensing button (not labeled), an ice-dispensing button (not labeled) and a heated water dispensing button (not labeled) for selecting between chilled liquid water, ice, and heated liquid water, respectively. The particular structure and operation of the refrigerator and dispensing system are understood by those of skill in the art and, as such, are not described in further detail herein for the sake of brevity.

According to various embodiments of the present disclosure, the household appliance 10 may take the form of any of the examples described above, or may be any other household appliance. Thus, it will be understood that the present subject matter is not limited to any particular household appliance.

It should be understood that “household appliance” and/or “appliance” are used herein to describe appliances typically used or intended for common domestic tasks, such as a laundry appliance, e.g., as illustrated in FIGS. 1 through 3, or an air conditioner appliance (see, e.g., FIG. 4), a dishwashing appliance, a refrigerator (see, e.g., FIG. 5), a water heater, etc., and any other household appliance which performs similar functions in addition to network communication and data processing. Thus, devices such as a personal computer, router, and other similar devices whose primary functions are network communication and/or data processing are not considered household appliances as used herein.

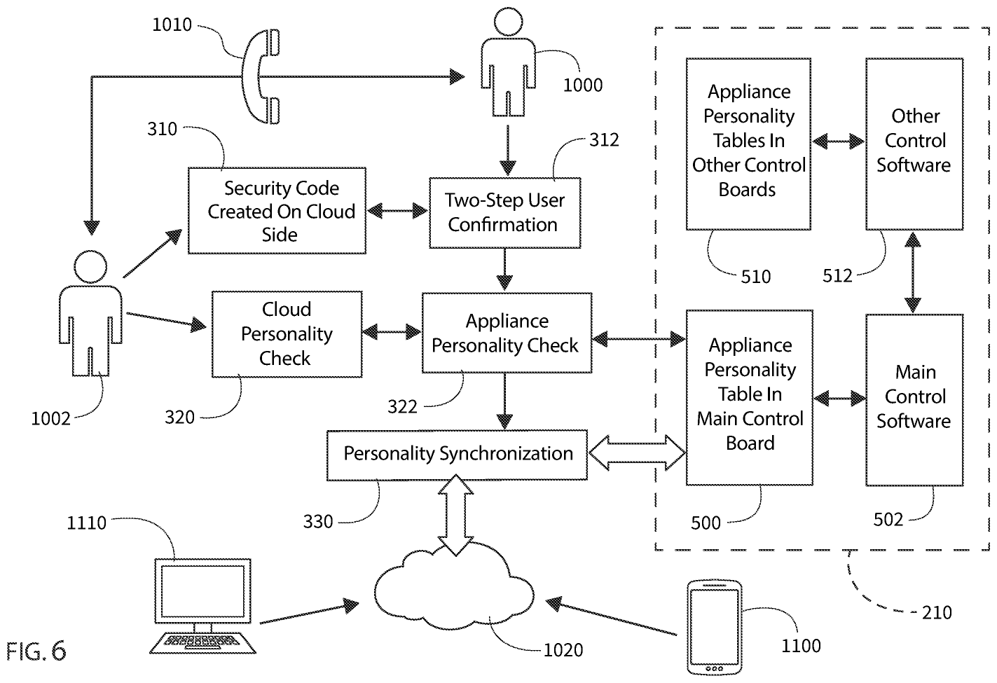

FIG. 6 provides a diagram of an exemplary system and flowchart steps of an exemplary method for managing a personality of a household appliance according to one or more embodiments of the present disclosure. The configuration, e.g., software and/or hardware configuration, as well as active or selected options or other settings, etc., of the household appliance may change over time throughout the life of the household appliance. The cumulative effect of such options and configurations, including hardware information such as component types and sources, etc., may be considered a personality of the household appliance, e.g., a particular combination of options and configurations that are specific to that individual appliance and which may vary from other appliances having a same model type or other commonalities. The personality of the household appliance may be updated or changed in various ways, e.g., in response to various inputs from various sources. The exemplary systems and methods of the present disclosure, such as those illustrated in FIG. 6 may provide multi-way, e.g., two-way, synchronization of personality information and redundant storage of the personality information. The exemplary systems and methods of the present disclosure, such as those illustrated in FIG. 6 may also provide a separate or partitioned storage for the personality of the household appliance.

The personality of the household appliance may include the specific appliance and model, as well as the serial number of the particular individual household appliance to be tested. For example, the personality of the household appliance may also include specifying a type or kind of one or more components of the household appliance, such as a motor of the household appliance and/or other similar components. The component type information may be correlated with the serial number of the household appliance in order to develop or establish an initial personality of the household appliance. As mentioned above, the personality of the household appliance may also be developed over time, e.g., as operation parameters or other configuration settings are adjusted in response to various inputs. Thus, the personality of the household appliance may include both hardware configuration information, e.g., a component source or type information, such as a wattage of a motor, etc., and software configuration information, e.g., a firmware version and/or date, selection values for various options, etc.

In addition to storing the personality of the household appliance, a history or genealogy of the household appliance may also be stored, such as stored with the personality in each location in which the personality is stored, and/or the personality of the household appliance may include such history. For example, the history may include a revision history, e.g., a reverse chronological listing of all changes, updates, and/or previous versions of the personality of the household appliance. In such embodiments, the revision history or other history or genealogy may also be used to restore a previous personality of the household appliance, such as in the event of an erroneous or incompatible update or change in the personality of the household appliance.

As mentioned above, the personality of the household appliance may be updated or changed by various sources. For example, the personality of the household appliance may be updated to reflect user-selected options or settings, which may be received as an input from a local user input, e.g., user input 102 as described above, or via the cloud 1020 from a remote user interface device 1100, e.g., as illustrated in FIG. 6. As another example, the appliance personality may be updated by a system engineer, such as by a firmware update deployed from a terminal 1110 and pushed to the household appliance through the cloud 1020. As still another example, the personality of the household appliance may be updated, such as to reflect changes made to the hardware and/or software, e.g., during a repair and/or maintenance of the household appliance, by a technician. The technician may provide an input for such an update to the personality of the household appliance locally or remotely. Changes to the personality by a remote technician 1002 may be subject to one or more verification steps or other security processes to prevent or reduce erroneous or malicious changes to the personality of the household appliance, as will be described in more detail below.

The terminal 1110 may be any suitable input means whereupon an update or change for one or more household appliances may be remotely configured and from which such update or change may be deployed. For example, a user, e.g., technician or engineer, etc., may access the terminal 1110 to configure or develop an update on the terminal 1110. In such embodiments, the terminal 1110 may then transmit, e.g., upload, the update to a cloud computing system 1020 for deployment to the one or more household appliances from the cloud 1020.

FIG. 6 schematically illustrates one or more remote computing devices in a distributed computing environment, such as a cloud 1020. The household appliance 10, and in particular the controller 210 thereof, may be in communication, e.g., wireless communication, with the cloud 1020. For example, the cloud 1020 may be or include one or more remote computing devices, such as remote computers, servers, and/or databases.

As mentioned, user input which results in a change or update to the personality of the household appliance may be received locally or remotely, e.g., via a remote user interface device 1100. The remote user interface device 1100 may be a laptop computer, smartphone, tablet, personal computer, wearable device, smart home system, and/or various other suitable devices.

The household appliance 10 may be in communication with the remote user interface device 1100 device through various possible communication connections and interfaces. The household appliance 10 and the remote user interface device 1100 may be matched in wireless communication, e.g., connected to the same wireless network. The household appliance 10 may communicate with the remote user interface device 1100 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the household appliance 10 and the remote user interface device 1100. For example, BLUETOOTH® Low Energy may advantageously minimize the power consumed by the exemplary methods and devices described herein due to the low power networking protocol of BLUETOOTH® Low Energy.

The remote user interface device 1100 is “remote” at least in that it is spaced apart from and not physically connected to the household appliance 10, e.g., the remote user interface device 1100 is a separate, stand-alone device from the household appliance 10 which communicates with the household appliance 10 wirelessly. Any suitable device separate from the household appliance 10 that is configured to provide and/or receive communications, information, data, or commands from a user may serve as the remote user interface device 1100, such as a smartphone (e.g., as illustrated in FIG. 6), smart watch, personal computer, smart home system, or other similar device. For example, the remote user interface device 1100 may be a smartphone operable to store and run applications, also known as “apps,” and some or all of the method steps disclosed herein may be performed by a smartphone app. The remote user interface device 1100 may include a memory for storing and retrieving programming instructions. Thus, the remote user interface device 1100 may provide a remote user interface which may be an additional user interface to the user interface panel 100. For example, the remote user interface device 1100 may be a smartphone operable to store and run apps, and the remote user interface may be provided as a smartphone app.

As mentioned above, controller 210 is capable of and may be operable to perform any methods and associated method steps as disclosed herein. In some embodiments, the performance of exemplary methods and associated method steps may be distributed, e.g., performed in part by the controller 210 and in part by one or more remote computing devices in the cloud 1020 and/or remote user interface device 1100.

As mentioned, updates to the personality of the household appliance may be made in response to inputs from various sources, such as a remote technician 1002. When the source is a remote technician, additional security steps may be included. As illustrated in FIG. 6, a local user 1000 of the household appliance may be connected to a remote technician 1002 via a phone 1010, such as when the local user 1000 calls for technical support such as troubleshooting or help with upgrading a household appliance. The remote technician 1002 may access the household appliance remotely, e.g., via the cloud 1020, and may perform cloud-side operations, e.g., operations 310 and 320, as will be explained in more detail below. The local user 1000 may be physically present at the same location as the household appliance, e.g., in the household, and the local user 1000 may thereby access the household appliance directly, such as by physically touching controls and/or input devices of the household appliance, e.g., pushing buttons, touchpads, and/or touchscreens physically connected to the household appliance. Thus, local operations, e.g., operations 312 and 322, which will be described in more detail below, may be performed by the household appliance in response to direct inputs from the local user 1000.

As illustrated in FIG. 6, before the personality of the household appliance is changed or updated, a two-step user confirmation, e.g., as shown at 310 and 312, may be performed. The remote technician 1002 may generate a security code on the cloud side, e.g., as shown at 310 in FIG. 6, and the security code may be transmitted to the household appliance, e.g., embedded or encoded in a signal that is relayed to the household appliance via the internet. The remote technician may then communicate the security code to the local user, e.g., over the phone 1010 connection illustrated in FIG. 6. As shown at 312 in FIG. 6, the local user may then enter the code directly into the household appliance to complete the two-step user confirmation. As denoted by the double arrow between 310 and 312 in FIG. 6, the security code entered by the local user must match the security code created by and received from the cloud side in order to complete the user confirmation.

Still referring to FIG. 6, the security process may further include steps for verifying the personality of the household appliance. For instance, different units of the same model household appliance may have different components, such as different motor types, and the motor type (and/or other component type) may be verified as part of the appliance personality verification. As denoted by the double arrow between 320 and 322 in FIG. 6, the appliance personality data on the household appliance, e.g., stored in a local memory of the household appliance, must match the household appliance personality data stored in the cloud side in order to complete the appliance personality verification. For example, the local user may provide the appliance serial number to the remote technician, e.g., by reading the serial number over the phone, and the remote technician may then enter the serial number into the cloud 1020, e.g., a remote database therein, whereupon the cloud database returns an appliance personality value (e.g., as shown at 320 in FIG. 6) that is matched against a local appliance personality value (e.g., as shown at 322 in FIG. 6) in order to verify the personality of the household appliance. Once the verification steps are complete, updates may be made to the personality of the household appliance, e.g., in a memory of the controller 210, as illustrated in FIG. 6, from a remote input, e.g., by the remote technician 1002.

As illustrated at 330 in FIG. 6, exemplary embodiments of the present disclosure may further include personality synchronization. As indicated by the larger double arrows in FIG. 6, the personality synchronization may be multi-way synchronization, such as two-way synchronization, such as two-way synchronization between the cloud 1020 and local memory of the controller 210.

In some embodiments, the local memory of the controller 210 may be partitioned, such as into at least a personality partition and a control partition, among other possible partitions. For example, the personality partition and the control partition may be provided within a single memory module of the controller, or may be provided in each of multiple physically distinct memory modules, such as, in embodiments where the household appliance includes multiple control boards, e.g., printed circuit boards (PCBs), each of the control boards may include a memory and each memory may include a personality partition and a control partition therein. For example, as illustrated in FIG. 6, the controller 210 may include multiple memory modules each with different software loaded therein. In some embodiments, the controller 210 may include memory of a main control board, and an appliance personality table 500 may be stored in the memory, e.g., a copy of the personality of the household appliance may be stored in a personality partition of the memory, where the memory may be the local memory of the controller 210, or one of the local memories incorporated in the controller 210. The main memory may further include main control software 502, e.g., loaded in a control partition thereof. Some embodiments may include, as mentioned above, a separate memory on a separate control board, such as memory of an other control board or boards, which may include appliance personality tables 510 therein, as illustrated in FIG. 6. The other control board or boards may also have a control partition with other control software 512 loaded therein. For example, in embodiments where the household appliance is a refrigerator appliance, the other control board may be a dedicated control board for the dispenser assembly with dispenser control software loaded therein, e.g., in a control partition thereof and with an additional copy of the personality of the household appliance stored in a personality partition thereof, e.g., as indicated at 510 in FIG. 6. In such embodiments, the other control board may provide an additional layer of redundancy in an additional backup for the personality of the household appliance.

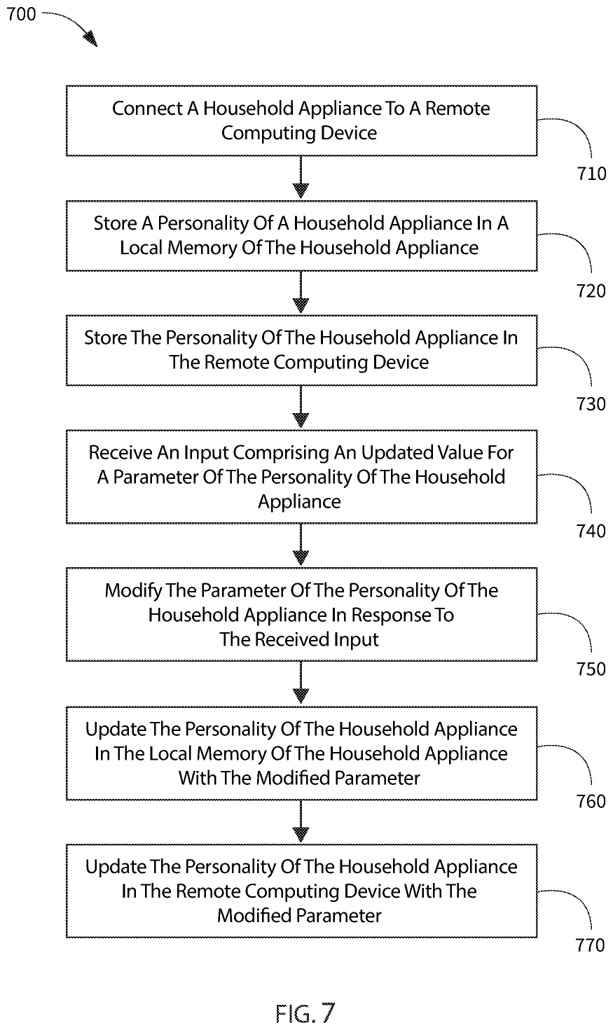

Turning now to FIG. 7, an example embodiment of a method 700 of operating a household appliance 10 in accordance with the present disclosure is illustrated in a flow chart diagram. As illustrated in FIG. 7, the method 700 may include a step 710 of connecting the household appliance to a remote computing device. Method 700 may further include a step 720 of storing a personality of the household appliance in a local memory of the household appliance and a step 730 of storing the personality of the household appliance in the remote computing device. Steps 720 and 730 may be performed in any order, such as the personality of the household appliance may be first stored in the local memory and then transmitted to and stored by the remote computing device or may be transmitted to the local memory from the cloud and then stored in the local memory.

Still referring to FIG. 7, method 700 may also include a step 740 of receiving an input comprising an updated value for a parameter of the personality of the household appliance. Method 700 may then include a step 750 of modifying the parameter of the personality of the household appliance in response to the received input. As mentioned above, the input may be received from one of several various sources. The parameter may be any information that is stored in the appliance personality, such as hardware information, software configurations or settings, etc., as described above. For example, the input may be or include information related to a new component of the household appliance, such as when a compressor of a refrigerator appliance is replaced with a different compressor. Such input may be manually entered or may be automatically generated, such as the controller of the household appliance may automatically detect the new component, e.g., motor, compressor, etc., and may then apply a new value to one or more parameters of the personality of the household appliance corresponding to the new component.

In some exemplary embodiments, the input may be received from a local user interface of the household appliance, such as a selected option or configuration of the household appliance, e.g., according to a user's preferences. In such embodiments, the step 750 of modifying the parameter of the personality of the household appliance in response to the received input may be performed by a controller of the household appliance. Thus, the personality of the household appliance in the remote computing device may be updated by transmitting the updated personality from the controller of the household appliance to the remote computing device, while the personality of the household appliance in the local memory is directly updated by the controller in response to the local user input, e.g., the personality of the household appliance may be updated by the controller and then synchronized with the cloud, e.g., one or more remote computing devices.

In some exemplary embodiments, the input may be received by the remote computing device, such as from a systems engineer or a user via a remote user interface device, etc. For example, the input may be or include a selection and/or purchase of a premium or post-market feature that is selected online (e.g., over the internet using a remote user interface device such as a laptop, smartphone, etc.) and downloaded to the household appliance from a remote computing device such as a remote server, e.g., in the cloud. In such embodiments, the step 750 of modifying the parameter of the personality of the household appliance in response to the received input may be performed by the remote computing device. Thus, the step 760 of updating the personality of the household appliance in the local memory of the household appliance may include transmitting the updated personality from the remote computing device to the local memory of the household appliance. In such embodiments, the personality of the household appliance in the remote computing device is directly updated by the remote computing device in response to the input received by the remote computing device, e.g., the personality of the household appliance may be updated in the cloud, e.g., by one or more remote computing devices, and then synchronized with the controller of the household appliance, such as with a local memory onboard the controller, from the cloud.

As mentioned, the personality of the household appliance may be synchronized back and forth between the local memory and the remote computing device (e.g., cloud), such as two-way synchronization of the personality of the household appliance. Thus, exemplary methods such as method 700 may include both a step 760 of updating the personality of the household appliance in the local memory of the household appliance with the modified parameter and a step 770 of updating the personality of the household appliance in the remote computing device with the modified parameter. For example, each time the personality is updated in either one of the local memory or the remote computing device, the personality may also be updated in the other of the local memory and the remote computing device. Thus, whether the input is received and the parameter is modified (e.g., steps 740 and 750 are performed) by the local memory or the remote computing device, the other of the local memory and the remote computing device may also be updated according to the two-way synchronization.

In some embodiments, the personality of the household appliance may be separated from other features, such as the main control software, as described above. For example, such embodiments may advantageously permit general updates to the household appliance, such as to the main control software thereof, without affecting, e.g., overwriting, the personality of the household appliance. For example, such embodiments may include methods such as method 700 wherein the local memory of the household appliance is a partitioned memory comprising a personality partition and a control partition, wherein the personality of the household appliance may be stored in the personality partition. In particular embodiments, the household appliance may include multiple control boards, which provides an additional opportunity for redundant storage and separate storage of the personality of the household appliance. For example, in some embodiments of method 700 the household appliance may include a controller which includes a first circuit board and a second circuit board, e.g., that are physically separate and distinct components. In such embodiments, the local memory of the household appliance may be a first memory onboard the first circuit board of the controller, and the second circuit board may include a second memory. In such embodiments, the second memory may also be a partitioned memory, e.g., may include a second personality partition and a second control partition. Thus, an additional copy of the personality of the household appliance may also be stored in the second memory, e.g., method 700 may further include storing the personality of the household appliance in the second personality partition of the second memory of the second circuit board of the controller. In such embodiments, when either of the first circuit board or the second circuit board (and the respective memories thereon) are updated, e.g., replaced or overwritten, the personality of the household appliance may be restored from the other memory on the other circuit board. For example, method 700 may also include copying the personality of the household appliance from the second personality partition to the first personality partition and/or copying the personality of the household appliance from the first personality partition to the second personality partition. Further, either of the first or second memories of the controller may provide a backup to the personality of the household appliance stored in the cloud, e.g., remote computing device. Thus, exemplary embodiments of method 700 may also include copying the personality of the household appliance from the second personality partition to the remote computing device.

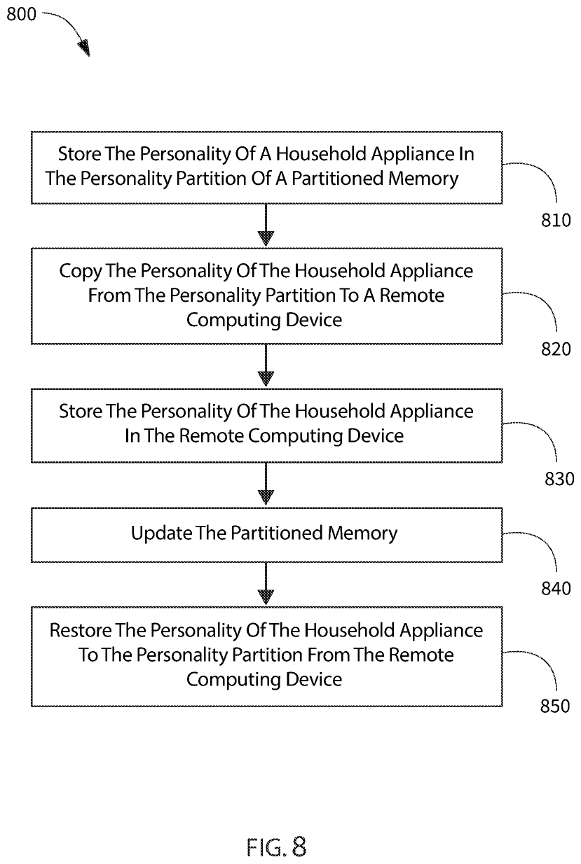

Turning now to FIG. 8, an example embodiment of a method 800 of operating a household appliance, such as one of the example household appliances 10 described above, in accordance with the present disclosure is illustrated in a flow chart diagram. The household appliance may include a controller having a partitioned memory. The partitioned memory may include a personality partition and a control partition. The method 800 may include a step 810 of storing a personality of the household appliance in the personality partition and a step 820 of copying the personality of the household appliance from the personality partition to a remote computing device. In such embodiments, the remote computing device, e.g., cloud, may also store a copy of the personality of the household appliance. For example, method 800 may further include a step 830 of storing the personality of the household appliance in the remote computing device.

Still referring to FIG. 8, in some embodiments, method 800 may include a step 840 of updating the partitioned memory. Such updates may include physically removing a current memory (including, for example, removing a circuit board on which the memory is embedded) and replacing the current memory with a new memory. Updating the partitioned memory may also include overwriting or resetting the memory, or otherwise changing the contents of the memory. Such updates may be intentional or unintentional, for example an unintentional update of the memory may occur in the event of a power surge or power loss. In some embodiments, method 800 may further include a step 850 of restoring the personality of the household appliance to the personality partition from the remote computing device after the update to the partitioned memory.

As mentioned above, the partitioned memory in method 800 may also be a single memory on a single circuit board (e.g., when the household appliance includes only the one circuit board), or may be a first partitioned memory on a first circuit board when the household appliance, e.g., the controller thereof, further includes a second circuit board with a second partitioned memory thereon which includes a second personality partition and a second control partition.

In some embodiments, method 800 may also include two-way synchronization, as mentioned above, such as synchronization from the controller to the remote computing device and/or from the remote computing device to the controller. For example, in some embodiments, method 800 may include receiving an input from a local user interface of the household appliance. In such embodiments, the input may include an updated value for a parameter of the personality of the household appliance. Thus, such embodiments of the method 800 may also include modifying the parameter of the personality of the household appliance in response to the received input, e.g., by the controller, updating the personality of the household appliance in the personality partition with the modified parameter, e.g., by the controller, and transmitting the updated personality of the household appliance to the remote computing device. As another example, in some embodiments, method 800 may include receiving, by the remote computing device, an input comprising an updated value for a parameter of the personality of the household appliance. In such embodiments, the method 800 may further include modifying, by the remote computing device, the parameter of the personality of the household appliance in response to the received input and updating a copy of the personality of the household appliance stored in the remote computing device with the modified parameter. Method 800 may then include, in such embodiments, transmitting the updated personality of the household appliance to the personality partition from the remote computing device.

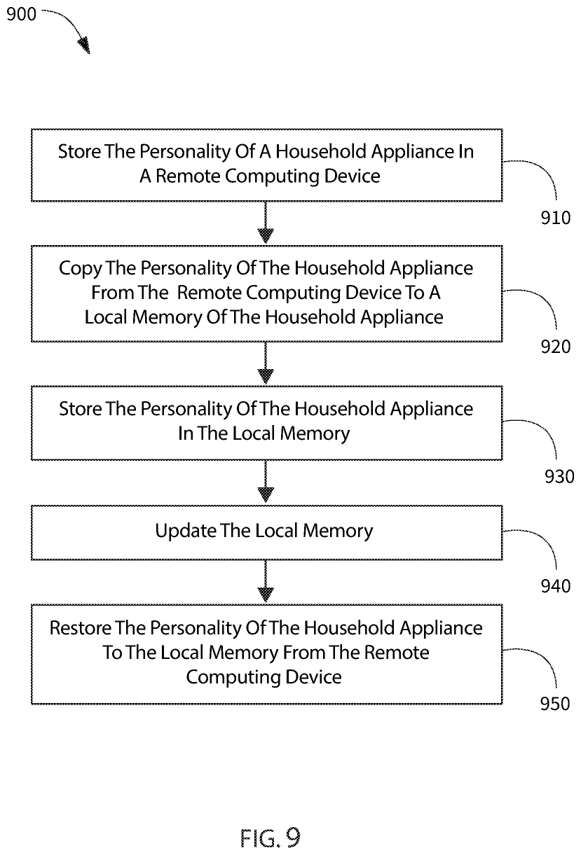

Turning now to FIG. 9, an example embodiment of a method 900 of operating a household appliance 10 in accordance with the present disclosure is illustrated in a flow chart diagram. The method 900 may include a step 910 of storing a personality of the household appliance in a remote computing device and a step 920 of copying the personality of the household appliance from the remote computing device to a local memory of the household appliance, e.g., a memory onboard a controller of the household appliance, which may, in some embodiments, be a partitioned memory. In some embodiments, method 900 may further include a step 930 of storing the personality of the household appliance in the local memory.

Still referring to FIG. 9, in some embodiments, method 900 may include a step 940 of updating the local memory. Such updates may include physically removing a current memory (including, for example, removing a circuit board on which the memory is embedded) and replacing the current memory with a new memory. Updating the local memory may also include overwriting or resetting the memory, or otherwise changing the contents of the memory, intentionally or unintentionally. In some embodiments, the remote computing device may provide a backup to the local memory, e.g., when the personality of the household appliance is synchronized between the local memory and the remote computing device. Thus, for example, method 900 may further include a step 950 restoring the personality of the household appliance to the local memory from the remote computing device after the update to the local memory. Additionally, the local memory may also provide a backup to the copy of the personality of the household appliance stored in the cloud, e.g., on the remote computing device, such as method 900 may also include copying the personality of the household appliance from the local memory to the remote computing device.

As mentioned above, the partitioned memory in method 900 may also be a single memory on a single circuit board (e.g., when the household appliance includes only the one circuit board), or may be a first partitioned memory on a first circuit board when the household appliance, e.g., the controller thereof, further includes a second circuit board with a second partitioned memory thereon which includes a second personality partition and a second control partition.

In some embodiments, method 900 may also include two-way synchronization, as mentioned above, such as synchronization from the controller to the remote computing device and/or from the remote computing device to the controller. For example, in some embodiments, method 900 may include receiving an input from a local user interface of the household appliance. In such embodiments, the input may include an updated value for a parameter of the personality of the household appliance. Thus, such embodiments of the method 900 may also include modifying the parameter of the personality of the household appliance in response to the received input, updating the personality of the household appliance in the local memory with the modified parameter, and transmitting the updated personality of the household appliance from the local memory to the remote computing device.

As another example, in some embodiments, method 900 may include receiving, by the remote computing device, an input comprising an updated value for a parameter of the personality of the household appliance. In such embodiments, the method 900 may further include modifying, by the remote computing device, the parameter of the personality of the household appliance in response to the received input and updating a copy of the personality of the household appliance stored in the remote computing device with the modified parameter. Method 900 may then include, in such embodiments, transmitting the updated personality of the household appliance to the local memory from the remote computing device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating a household appliance, the method comprising:
connecting the household appliance to a remote computing device;
storing a personality of the household appliance in a local memory of the household appliance, the personality of the household appliance comprising software configuration of the household appliance and hardware configuration of the household appliance, wherein the hardware configuration of the household appliance comprises a configuration of a motor of the household appliance;
storing the personality of the household appliance in the remote computing device;
receiving an input comprising an updated value for a parameter of the personality of the household appliance;
modifying the parameter of the personality of the household appliance in response to the received input;
updating the personality of the household appliance in the local memory of the household appliance with the modified parameter; and
updating the personality of the household appliance in the remote computing device with the modified parameter.

2. The method of claim 1, wherein the input is received from a local user interface of the household appliance, wherein modifying the parameter of the personality of the household appliance in response to the received input is performed by a controller of the household appliance, and wherein updating the personality of the household appliance in the remote computing device comprises transmitting the updated personality from the controller of the household appliance to the remote computing device.

3. The method of claim 1, wherein the input is received by the remote computing device, wherein modifying the parameter of the personality of the household appliance in response to the received input is performed by the remote computing device, and wherein updating the personality of the household appliance in the local memory of the household appliance comprises transmitting the updated personality from the remote computing device to the local memory of the household appliance.

4. The method of claim 1, wherein the local memory of the household appliance is a partitioned memory comprising a personality partition and a control partition, and wherein the personality of the household appliance is stored in the personality partition.

5. The method of claim 4, wherein the household appliance comprises a controller, wherein the local memory of the household appliance is a first memory onboard a first circuit board of the controller, wherein the controller further comprises a second circuit board, the second circuit board comprising a second memory, the second memory is a partitioned memory comprising a second personality partition and a second control partition, further comprising storing the personality of the household appliance in the second personality partition of the second memory of the second circuit board of the controller.

6. The method of claim 5, further comprising copying the personality of the household appliance from the second personality partition to the first personality partition.

7. The method of claim 5, further comprising copying the personality of the household appliance from the second personality partition to the remote computing device.

8. The method of claim 1, wherein the personality of the household appliance comprises a revision history.

9. A method of operating a household appliance, the household appliance comprising a controller having a partitioned memory, the partitioned memory comprising a personality partition and a control partition, the method comprising:
storing a personality of the household appliance in the personality partition, the personality of the household appliance comprising software configuration of the household appliance and hardware configuration of the household appliance, wherein the hardware configuration of the household appliance comprises a configuration of a motor of the household appliance;
copying the personality of the household appliance from the personality partition to a remote computing device;
storing the personality of the household appliance in the remote computing device;
updating the partitioned memory; and
restoring the personality of the household appliance to the personality partition from the remote computing device.

10. The method of claim 9, wherein the personality partition and the control partition are partitions of a memory on a single circuit board of the controller.

11. The method of claim 9, wherein the controller comprises a first circuit board and a second circuit board, wherein the personality partition is a first personality partition in a first memory of the first circuit board and the control partition is a first control partition in the first memory, and wherein a second memory of the second circuit board is a partitioned memory comprising a second personality partition and a second control partition.

12. The method of claim 9, further comprising receiving an input from a local user interface of the household appliance, the input comprising an updated value for a parameter of the personality of the household appliance, modifying the parameter of the personality of the household appliance in response to the received input, updating the personality of the household appliance in the personality partition with the modified parameter, and transmitting the updated personality of the household appliance to the remote computing device.

13. The method of claim 9, further comprising receiving, by the remote computing device, an input comprising an updated value for a parameter of the personality of the household appliance, modifying, by the remote computing device, the parameter of the personality of the household appliance in response to the received input, updating a copy of the personality of the household appliance stored in the remote computing device with the modified parameter, and transmitting the updated personality of the household appliance to the personality partition from the remote computing device.

14. The method of claim 9, wherein the personality of the household appliance comprises a revision history.

15. A method of operating a household appliance, the method comprising:
storing a personality of the household appliance in a remote computing device, the personality of the household appliance comprising software configuration of the household appliance and hardware configuration of the household appliance, wherein the hardware configuration of the household appliance comprises a configuration of a motor of the household appliance;
copying the personality of the household appliance from the remote computing device to a local memory of the household appliance;
storing the personality of the household appliance in the local memory;
updating the local memory; and
restoring the personality of the household appliance to the local memory from the remote computing device.

16. The method of claim 15, wherein the local memory of the household appliance is a partitioned memory comprising a personality partition and a control partition, and wherein the personality of the household appliance is stored in the personality partition.

17. The method of claim 15, further comprising copying the personality of the household appliance from the local memory to the remote computing device.

18. The method of claim 15, further comprising receiving an input from a local user interface of the household appliance, the input comprising an updated value for a parameter of the personality of the household appliance, modifying the parameter of the personality of the household appliance in response to the received input, updating the personality of the household appliance in the local memory with the modified parameter, and transmitting the updated personality of the household appliance from the local memory to the remote computing device.

19. The method of claim 15, wherein the personality of the household appliance comprises a revision history.
